(19) United States
(12) Patent Application Publication
(10) Pub. No.: US 2002/0075286 A1
(43) Pub. Date: Jun. 20, 2002

(54) Image generating system and method and storage medium

(76) Inventors: Hiroki Yonezawa, Kanagawa (JP); Kenji Morita, Kanagawa (JP)

Correspondence Address: Robin, Blecker & Daley, 330 Madison Avenue, New York, NY, 10017, US

(21) Appl. No.: 10/000,668

(22) Filed: Nov. 15, 2001

(30) Foreign Application Priority Data
Nov. 17, 2000 (JP) 2000-351995

(51) Int. Cl. G09G 5/00

(52) U.S. Cl. 345/679

(57) ABSTRACT

An image generating system is provided which is capable of reducing the time difference between the real space image and the virtual space image to thereby provide a more real composite image for the observer. A video camera captures an image of a real space at an observer's eye position and in the observer's line-of-sight direction. A line-of-sight detecting device detects the observer's eye position and line-of-sight direction. A virtual space image generator generates a virtual space image at the observer's eye position and in the observer's line-of-sight direction, the position and orientation being detected by the line-of-sight detecting device. A composite image generator generates a composite image by synthesizing the virtual space image generated by the virtual space image generator and a real space image outputted by the video camera. A display device displays the composite image generated by the composite image generator. A managing system collectively manages information on objects present in the real space and the virtual space as well as locations and orientations thereof.

### BACKGROUND OF THE INVENTION

1. Field of the Invention

The present invention relates to an image generating system and method that generates a composite image by synthesizing a real space image captured from photographing means such as a video camera and a virtual space image such as computer graphics, and a storage medium storing a program for implementing the method.

2. Description of the Related Art

A mixed reality system using a conventional HMD (Head Mounted Display) as a display device has been proposed by Ohshima, Sato, Yamamoto, and Tamura (refer to Ohshima, Sato, Yamamoto, and Tamura “AR2 Hockey: Implementation of A Collaborative Mixed Reality System, Journal, Vol. 3, No. 2, pp. 55-50, 1998 published by The Virtual Reality Society of Japan, for example).

However, with this conventional system, a phenomenon can be observed that when an observer shakes his head, a real space image immediately follows his motion, whereas a virtual space image lags behind the real space image. That is, a significant time difference can occur between the real space image and the virtual space image.

### SUMMARY OF THE INVENTION

It is an object of the present invention to provide an image generating system and method that is capable of reducing the time difference between the real space image and the virtual space image to thereby provide a more real composite image for the observer, and a storage medium storing a program for implementing the method.

To attain the above object, a first aspect of the present invention provides an image generating system comprising image pickup means for capturing an image of a real space at an eye position of an observer and in a line-of-sight direction of the observer, detecting means for detecting the eye position of the observer and the line-of-sight direction of the observer, virtual space image generating means for generating an image of a virtual space at the eye position of the observer and in the line-of-sight direction of the observer, the eye position and the line-of-sight direction being detected by the detecting means, composite image generating means for generating a composite image by synthesizing the image of the virtual space generated by the virtual space image generating means and the image of the real space outputted by the image pickup means, display means for displaying the composite image generated by the composite image generating means, and managing means for collectively managing information on objects present in the real space and the virtual space as well as locations and orientations thereof.

Preferably, the managing means can update the information on the objects present in the real space and the virtual space as well as the locations, orientations, and status thereof.

More preferably, the managing means notifies the composite image generating means of the information on the objects present in the real space and the virtual space as well as the locations, orientations, and status thereof, at predetermined time intervals.

Further preferably, the virtual space image generating means is responsive to the updating of the information by the managing means, for generating the image of the virtual space based on the information on the objects present in the real space and the virtual space as well as the locations and orientations thereof.

Also preferably, the composite image generating means is responsive to the updating of the information by the managing means, for starting drawing the image of the real space.

In a preferred embodiment, the composite image generating means synthesizes the image of the real space and the image of the virtual space after the composite image generating means has completed drawing image of the real space and the virtual space image generating means has then generated the image of the virtual space.

In a more preferred embodiment, the composite image generating means regenerates the image of the virtual space based on the eye position of the observer and the line-of-sight direction of the observer detected by the detecting means, immediately before synthesizing the image of the real space and the image of the virtual space.

In a preferred embodiment, the virtual space image generating means executes a process of generating an image of the virtual space based on the information on the objects present in the real space and the virtual space as well as the locations and orientations thereof, according to the information updated by the managing means, and the composite image generating means executes a process of starting drawing the image of the real space in parallel with the process of generating the image of the virtual space, executed by the virtual space image generating means.

In a typical application of the present system such as a game, usually the observer comprises a plurality of observers.

In such a case, advantageously the image generating system further comprises operation detecting means for detecting an operation of the observer including a gesture and status thereof based on results of the detection by the detecting means.

Preferably, the operation of the observer detected by the operation detecting means can be used as an input that acts on a space in which the composite image is present and objects present in the space.

To attain the above object, a second aspect of the present invention also provides an image generating method of generating a composite image by synthesizing an image of a virtual space on an image of a real space obtained at an eye position of an observer and in the line-of-sight direction of the observer, the method comprising the steps of detecting the eye position and the line-of-sight direction of the observer, obtaining the image of the real space at the eye position of the observer and in the line-of-sight direction of the observer, obtaining management information containing objects present in the real space and the virtual space as well as locations and orientations thereof, generating the image of the virtual space at the eye position of the observer and in the line-of-sight direction of the observer based on the management information, and generating a composite image by synthesizing the image of the virtual space and the image of the real space based on the management information.

To attain the above object, a second aspect of the present invention further provides a computer-readable storage medium storing a program for generating a composite image, which is executed by an image generating system comprising image pickup means for capturing an image of a real space at an eye position of an observer and in a line-of-sight direction of the observer, detecting means for detecting the eye position of the observer and the line-of-sight direction of the observer, and display means for displaying a composite image obtained by synthesizing the image of the real space and an image of a virtual space generated at the eye position of the observer and in the line-of-sight direction of the observer, the program comprisinga detecting module for causing the detecting means to detect an eye position and line-of-sight direction of an observer, a virtual space image generating module for generating an image of a virtual space at the eye position of the observer and in the line-of-sight direction of the observer, the eye position and the line-of-sight direction being detected by the detecting module, a composite image generating module for generating a composite image from the image of the virtual space generated by the virtual space image generating module and an image of a real space, and a managing module for collectively managing objects present in the real space and the virtual space as well as locations and orientations thereof.

The above and other objects, features, and advantages of the present invention will be apparent from the following specification taken in conjunction with the accompanying drawings.

### BRIEF DESCRITION OF THE DRAWINGS

FIG. 1 is a schematic view showing the arrangement of an image generating system according to an embodiment of the present invention;

FIGS. 2A and 2B are perspective views showing the construction of an HMD which is mounted on an observer's head;

FIG. 3 is a view showing an example of an MR space image generated when all virtual space objects are located closer to the observer than real space objects;

FIG. 4 is a view showing an example of an MR space image generated when no transparent virtual space object is used;

FIG. 5 is a view showing an example of an MR space image generated when a transparent virtual space object is used;

FIG. 6 is a view showing an example of a deviation correction executed by the image generating system in FIG. 1 using markers;

FIG. 7 is a view showing the hardware configuration of a computer 107 in the image generating system in FIG. 1;

FIG. 8 is a view showing the configuration of software installed in the image generating system in FIG. 1;

FIG. 9 is a view schematically showing hardware and software associated with generation of an MR space image by the image generating system in FIG. 1 as well as a flow of related information;

FIG. 10 is a timing chart showing operation timing for the MR vide generating software in FIG. 9; and

FIG. 11 is a flow chart showing the operation of the MR image generating software in FIG. 9.

### DESCRIPTION OF THE PREFERRED EMBODIMENTS

The present invention will be described below with reference to the drawings showing a preferred embodiment thereof.

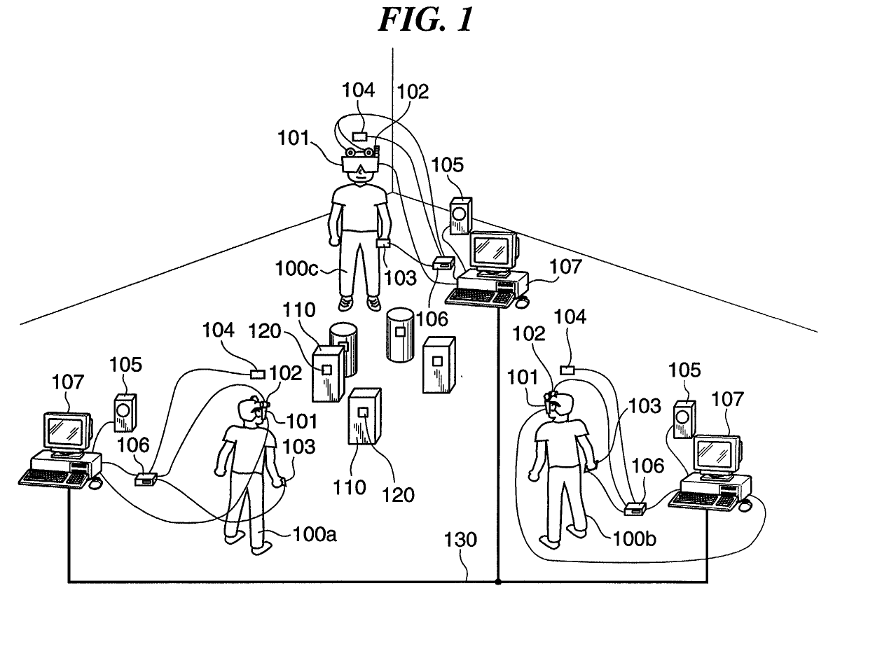

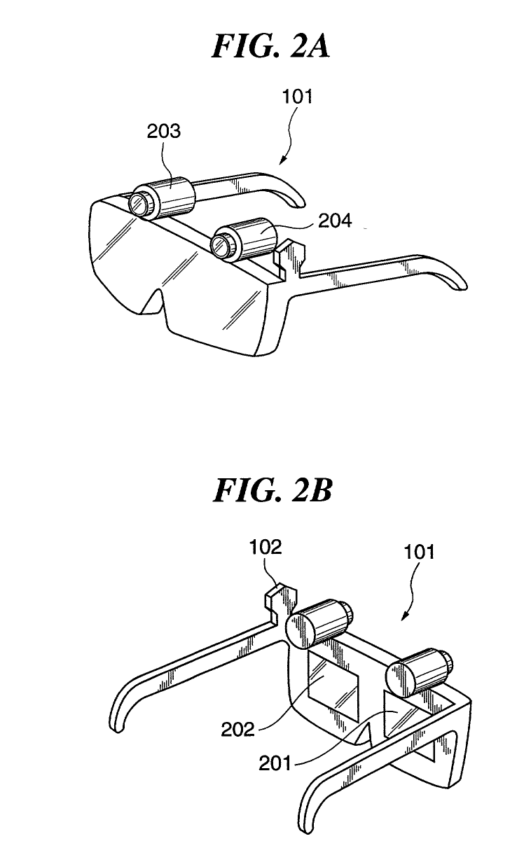

FIG. 1 is a view schematically showing the arrangement of an image generating system according to an embodiment of the present invention, which displays a composite image. FIGS. 2A and 2B are perspective views showing the configuration of an HMD which is adapted to be mounted on the head of an observer in FIG. 1.

In the present embodiment, as shown in FIG. 1, the system is mounted in a room of 5×5 m size, and three observers 100a, 100b, and 100c experience mixed reality. The mounting location and size of the system, and the number of observers are not limited to the illustrated example but can be freely changed.

The observers 100a, 100b, and 100c each have mounted on his head an HMD (head mounted display) 101 that provides a mixed reality space image (hereinafter referred to as “the MR space image”) to him, and also have mounted on his head a head position and orientation sensory receiver 102 that detects the position and orientation of his head, and have mounted on the right hand (for example, the observer's dominant hand) a hand position and orientation sensory receiver 103 that detects the position and orientation of his hand.

The HMD 101 has a right-eye display device 201 and a left-eye display device 202, and a right-eye video camera 203 and a left-eye video camera 204, as shown in FIGS. 2A and 2B. The display devices 201 and 202 are each comprised of a color liquid crystal and a prism and display an MR space image corresponding to the observer's eye position and line-of-sight direction.

A virtual space image seen from the position of the right eye is superposed on a real space image photographed by the right-eye video camera 203 so that a right-eye MR space image is generated. This right-eye MR space image is displayed on the right-eye display device 201. A real space image photographed by the left-eye video camera 204 is superposed on a virtual space image seen from the position of the left eye so that a left-eye MR space image is generated. This left-eye MR space image is displayed on the left-eye display device 202. By thus displaying the respective corresponding MR space images on the left-and right-eye display devices 201 and 202, the observer can enjoy stereographic viewing of the MR space. Only one video camera may be used so as not to provide stereoscopic images.

The head position and orientation sensory receiver 102 and the hand position and orientation sensory receiver 103 receive an electromagnetic or ultrasonic wave emitted from a position and orientation sensory transmitter 104, which makes it possible to determine the positions and orientations of the sensors based on the receiving intensity or phase of the wave. This position and orientation sensory transmitter 104 is fixed at a predetermined location within a space used as a game room, and acts as a reference for detecting the positions and orientations of each observer's head and hand.

In this case, the head position and orientation sensory receiver 102 detects the observer's eye position and line-of-sight direction. In the present embodiment, the head position and orientation sensory receiver 102 is fixed to the HMD 101 on each observer's head. The hand position and orientation sensory receiver 103 measures the position and orientation of the observer's hand. If information on the position and orientation of the observer's hand is required in a mixed reality space (hereinafter referred to as “the MR space”), for example, if the observer holds an object in a virtual space or any required state varies depending on the movement of his hand, the hand position and orientation sensory receiver 103 is mounted. Otherwise, the hand position and orientation sensory receiver 103 may not be mounted. Further, if information on any part of the observer's body, a sensor receiver may be mounted on that part.

Provided in the vicinity of each of the observers 100a, 100b, and 100c are the position and orientation sensory transmitter 104, a speaker 105, a position and orientation sensory main body 106 to which are connected the head position and orientation sensory receiver 102, the hand position and orientation sensory receiver 103, and the position and orientation sensory transmitter 104, and a computer 107 that generates an MR space image for each of the observers 100a, 100b, and 100c. In the illustrated example, the position and orientation sensory main body 106 and the computer 107 are mounted in proximity to the corresponding observer, but they may be mounted apart from the observer. Further, a plurality of real space objects 110 that are to be merged with an MR space to be observed are provided and arranged in a manner corresponding to the MR space to be generated. The real space objects 110 may be an arbitrary number of objects.

The speaker generates a sound corresponding to an event occurring in the MR space. Such a sound corresponding to an event may be, for example, an explosive sound that is generated if characters in a virtual space collides against each other. The coordinates of the speaker 105 in the MR space are stored in advance in the system. If any event involving any sound occurs, the speaker 105 mounted in the vicinity of the MR space coordinates at which the event has occurred generates an explosive sound. An arbitrary number of speakers 105 are arranged at arbitrary locations so as to give the observers a proper feeling of presence.

Further, instead of arranging such speakers 105, HMDs with headphones mounted thereon may be used to realize the acoustic effects of the system. In this case, only particular observers wearing the HDMs can hear the sound, and therefore a virtual sound source called “3D audio” must be used.

A specific example of the real space objects 110 may be such a set as used for an attraction in an amusement facility. The set to be prepared depends on the type of MR space provided for the observers.

Several thin colored pieces called “markers 120” are stuck to the surfaces of the real space objects 110. The markers 120 are used to correct deviation between real space coordinates and virtual space coordinates using image processing. This correction will be described later.

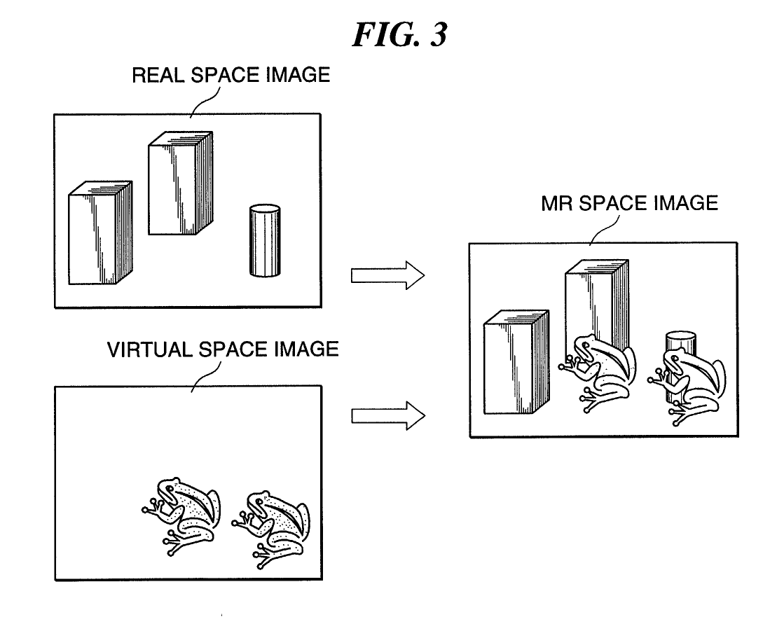

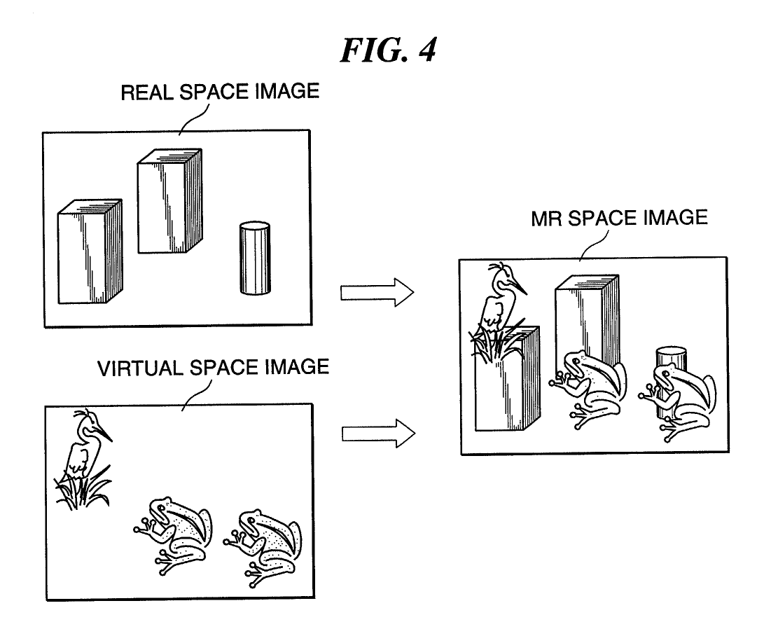

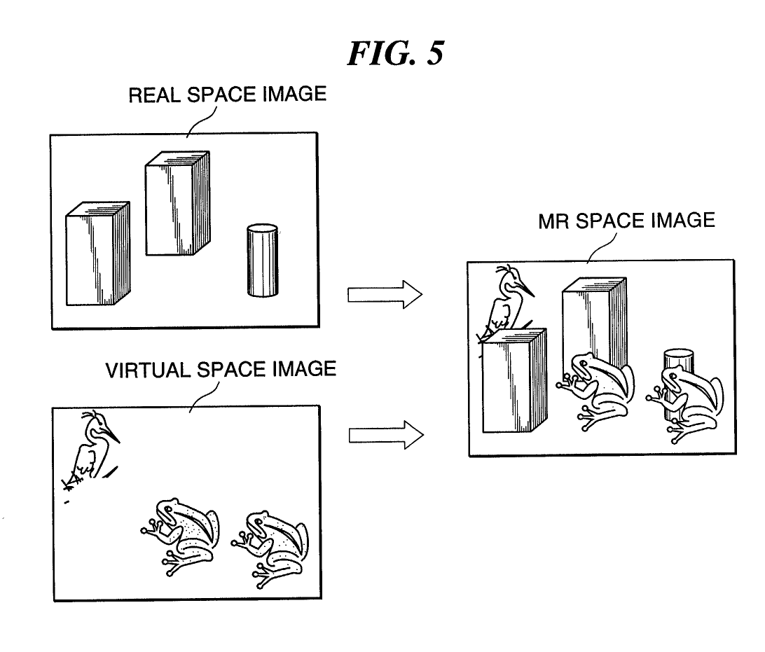

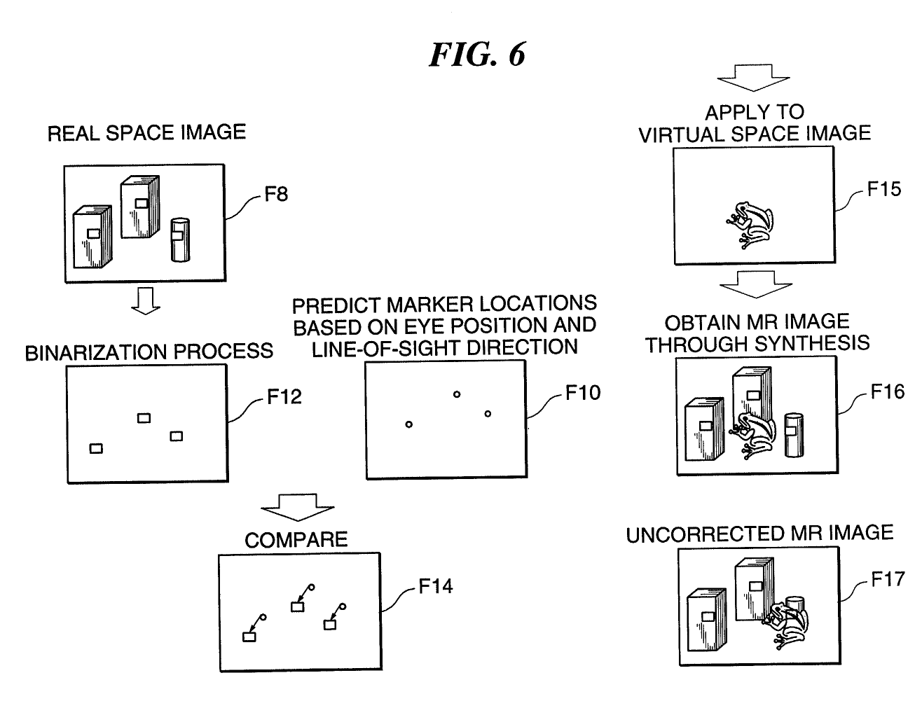

Next, main points of the generation of an MR space image displayed on the HMD 101 will be described with reference to FIGS. 3 to 6. FIG. 3 is a view showing an example of an MR space image generated when all virtual space objects are closer to the observer than real space objects. FIG. 4 is a view showing an example of an MR space image generated when no transparent virtual space object is used. FIG. 5 is a view showing an example of an MR space image generated when a transparent virtual space object is used. FIG. 6 is a view showing an example of a deviation correction executed by the image generating system in FIG. 1 using markers.

An MR space image is displayed to each of the observers 100a, 100b, and 100c through the HMD 101 in real time in such a manner that a virtual space image is superposed on a real space image to make the observer feel as if virtual space objects were present in the real space, as shown in FIG. 3. To improve the sense of merging in generating an MR space image, processing with MR space coordinates, processing on the superposition of a transparent virtual object, and/or a deviation correcting process using markers is required. Each of these processes will be described below.

First, the MR space coordinates will be described. If an MR space is to be generated such that the observers 100a, 100b, and 100c interact with virtual space objects merged in the MR space, for example, any observer taps any CG character to cause it to show a certain reaction, whether or not the observer has come into contact with the CG character cannot be determined if the real space and the virtual space use difference coordinate axes. Thus, the present system converts the coordinates of real and virtual space objects to be merged with the MR space into an MR space coordinate system, on which all the objects are handled.

For the real space objects 110, the observer's eye position and line-of-sight direction, the position and orientation of the observer's hand (measured values of the position and orientation sensor), information on the locations and shapes of the real space objects 110, information on the locations and shapes of the other observers are converted into the MR coordinate system. Similarly, for the virtual space objects, information on the locations and shapes of the virtual space objects to be merged with the MR space is converted into the MR coordinate system. By thus introducing the MR space coordinate system and converting the real space coordinate system and virtual space coordinate system into the MR space coordinate system, the positional relationship and distances between the real space objects and the virtual space objects can be uniformly handled, thereby achieving the interactions.

Now, the problem with the superposition will be described. An MR space image is generated by superposing a virtual space image on a real space image, as shown in FIG. 3. In the FIG. 3 example, in the MR space coordinates, no problem occurs because all the virtual space objects are present closer to the observer than the real space objects as viewed from the observer's eye position. However, if any virtual space object is present behind one or more real space objects, this virtual space image is displayed in front of the real space object(s), as shown in FIG. 4. Therefore, the coordinates of the real space objects and the coordinates of the virtual objects are compared with each other before superposition, and processing is carried out such that any object or objects which are located farther from the observer's eyes are hidden by any related object or objects which are located closer to the observer.

To achieve the above processing, if any real space objects are to be merged with the MR space, transparent virtual space objects having the same shapes, locations, and orientations as the real space objects and the background of which is made transparent are defined in advance in the virtual space. For example, as shown in FIG. 5, transparent virtual objects having the same shapes as the three objects in the real space are defined in the virtual space. By thus using such transparent virtual space object or objects, when the real image is synthesized, the real image is not overwritten, and only any virtual space object or objects located behind any real space object or objects can be deleted.

Next, deviation between the real space coordinates and the virtual space coordinates will be described. The positions and orientations of the virtual space objects are mathematically determined, whereas the real space objects are measured using the position and orientation sensor. Accordingly, certain errors may occur in the measured values. Such errors may result in positional deviation between the real space objects and the virtual space objects in the MR space when an MR space image is generated.

Then, the markers 120 are used to correct such deviation. The markers 120 may be small rectangular pieces of about 2 to 5 cm square which have a particular color or a combination of particular colors that are not present in the real space to be merged in the MR space.

An explanation will be given of the procedure for correcting positional deviation between the real space and the virtual space using the markers 120 with reference to FIG. 6. It is assumed that the coordinates of the markers 120 on the MR space are previously defined in the system.

As shown in FIG. 6, first, the observer's eye position and line-of-sight direction measured by the head position and orientation sensory receiver 102 are converted into the MR coordinate system to create an image of the markers as predicted from the observer's eye position and line-of-sight direction in the MR coordinate system (F10). On the other hand, an image of the extracted marker locations is created from the real space image.

Then, the two images are compared with each other, and the amount of deviation between the images in the MR space in the observer's line-of-sight direction is calculated on the assumption that the observer's eye position in the MR space is correct (F14). By applying the calculated amount of deviation to the observer's line-of-sight direction in the MR space, errors that occur between the virtual space objects and the real space objects in the MR space can be corrected (F15 and F16). For reference, an example in which no deviation correction using the markers 120 is executed in the above example is shown at F17 in FIG. 6.

Now, a description will be given of the hardware and software configurations of the computer 107 which executes the processes of the present system, as well as the operation of the software.

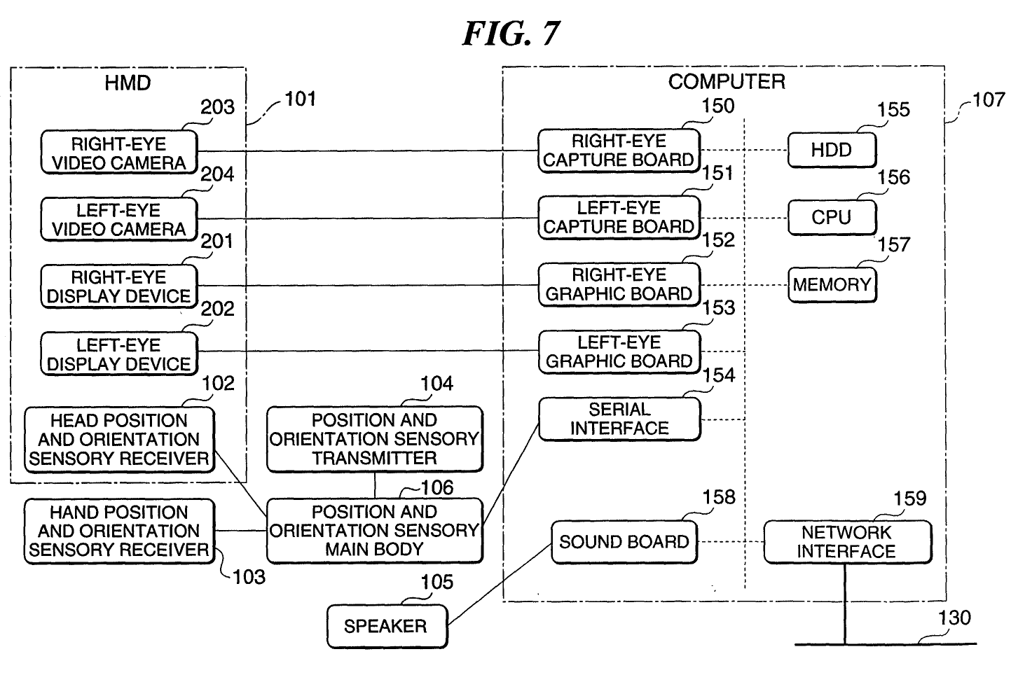

First, the hardware configuration of the computer 107 will be described with reference to FIG. 7. FIG. 7 shows the configuration of the hardware of the computer 107 in the image generating system in FIG. 1. To increase the number of observers, this configuration may be added depending on the increased number of the observers.

The computer 107 is provided for each of the observers 100a, 100b, and 100c as shown in FIG. 1, to generate a corresponding MR space image. The computer 107 is provided with a right-eye video capture board 150, a left-eye video capture board 151, a right-eye graphic board 152, a left-eye graphic board 153, a sound board 158, a network interface 159, and a serial interface 154. These pieces of equipment are each connected to a CPU 156, an HDD (hard disk drive) 155, and a memory 157 via a bus inside the computer.

The right-eye video capture board 150 has a right-eye video camera 203 of the HMD 101 connected thereto, and the left-eye video capture board 151 has a left-eye video camera 204 of the HMD 101 connected thereto. The right-eye graphic board 152 has a right-eye display device 201 of the HMD 101 connected thereto, and the left-eye graphic board 153 has a left-eye display device 202 of the HMD 101 connected thereto.

The speaker 105 is connected to sound board 158, and the network interface 159 is connected to a network such as a LAN (Local Area Network). Connected to the serial interface 154 is the position and orientation sensory main body 106, to which are in turn connected the head position and orientation sensory receiver 102, the hand position and orientation sensory receiver 103, and the position and orientation sensory transmitter 104.

The right-eye and left-eye video capture boards 150 and 151 digitize video signals from the right-eye and left-eye video cameras 203 and 204, respectively, and load the digitized signals into the memory 157 of the computer 107 at a rate of 30 frames/sec. The thus captured real space image is superposed on a virtual space image generated by the computer 107, and the resulting superposed image is outputted to the right-eye and left-eye graphic boards 152 and 153 and then displayed on the right-eye and left-eye display devices 201 and 202.

The position and orientation sensory main body 106 calculates the positions and orientations of the head position and orientation sensory receiver 102 and the hand position and orientation sensory receiver 103 based on the intensities or phases of electromagnetic waves received by the position and orientation sensory receivers 102 and 103. The calculated positions and orientations are transmitted to the computer 107 via the serial interface 54.

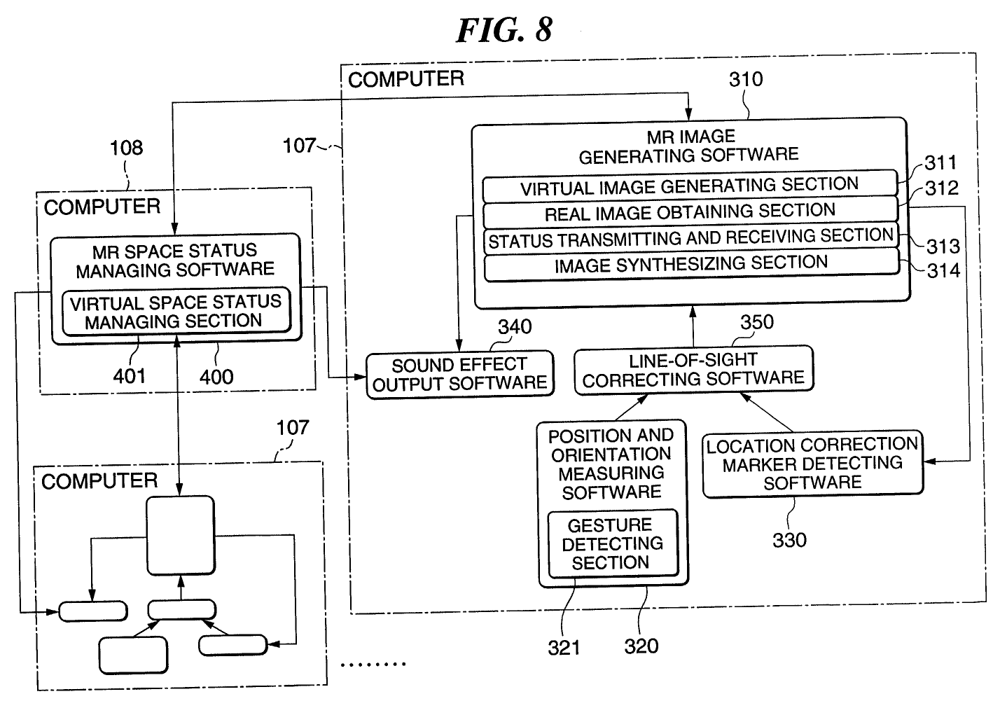

Connected to the network 130 connecting to the network interface 159 are the computers 107 for the observers 100a, 100b, and 100c and a computer 108, described later and shown in FIG. 8, which manages the status of the MR space.

The computers 107 corresponding to the respective observers 100a, 100b, and 100c share the detected eye positions and line-of-sight directions of the observers 100a, 100b, and 100c and the positions and orientations of the virtual space objects with the computer 108 by way of the network 130. Thus, each of the computers 107 can independently generate an MR space image for the corresponding one of the observers 100a, 100b, and 100c.

Further, if a music performance event occurs in the MR space, the speaker 105 mounted in the vicinity of the MR space coordinates at which the music performance event has occurred emits sound, and a command indicating which of the computers is to play the music is also transmitted via the network 130.

In the present embodiment, no special video equipment such as a three-dimensional converter is used and one computer is used for one observer. However, the input system may be comprised of a single capture board that generates a Page Flip video using a three-dimensional converter, or the output system may be comprised of a single graphic board having two outputs or a single graphic board that provides an Above&Below output, from which a down converter extracts images.

Now, the software configuration of the computer 107, which executes the processes of the present system, as well as the operations of the software will be described with reference to FIG. 8. FIG. 8 is a view showing the configuration of software installed in the image generating system in FIG. 1.

In the computer 107, as shown in FIG. 8, software is operated, including position and orientation measuring software 320, position correction marker detecting software 330, line-of-sight direction correcting software 350, sound-effect output software 340, and MR space image generating software 310.

These pieces of software are stored in the HDD 155 and are read out from the HDD 155 for execution by the CPU 156.

The computers 107 for the observers 100a, 100b, and 100c are connected to the computer 108, on which MR space status managing software 400 is operated.

In the present embodiment, the MR space status managing software 400 is operated on the computer 108, which is separate from the computer 107 which is provided for each observer to generate an MR space image. However, the MR space status managing software 400 may be operated on the computer 107, if its processing capability affords.

The position and orientation measuring software 320 communicates with the position and orientation sensory main body 105 to measure the positions and orientations of the position and orientation sensory receivers 102 and 103. The observer's eye position and line-of-sight direction at the MR space coordinates are calculated based on the measured values, and the calculated values are transmitted to the line-of-sight direction correcting software 350 together with the position and orientation from the hand position and orientation sensory receiver 103.

A gesture detecting section 321 in the position and orientation measuring software 320 detects a gesture of the observer estimated from the positions and orientations of the position and orientation sensors 102 and 103, the relationship between them, and changes in them with time. The detected gesture is transmitted to the line-of-sight direction correcting software 350.

The position correction marker detecting software 330 detects the markers 120 on a still image of the real space transmitted from a real image obtaining section 312 of the MR image generating software 310, and notifies the line-of-sight direction correcting software 350 of the locations of the markers on the image.

The line-of-sight direction correcting software 350 calculates, based on the observer's eye position and line-of-sight direction obtained by the position and orientation measuring software 320, the locations of the markers 120 in an MR space image displayed at the observer's eye position and in the observer's line-of-sight direction. The calculated or predicted marker locations are compared with the actual locations of the markers in the image detected by the position correcting marker detecting software 330, and the observer's line-of-sight direction is corrected so that positional deviation in the image obtained as a result of the comparison occurs. The thus corrected line-of-sight direction and eye position in the MR space image, and the position and orientation from the hand position and orientation sensory receiver 103, and the detected gesture, if required, are transmitted to the MR image generating software 310.

The sound effect output software 340 produces predetermined effect sounds or background music (BGM) according to a command from the MR image generating software 310 or the MR space status managing software 400. The MR image generating software 310 and the MR status managing software 400 are set in advance to recognize the mounting location of the speaker 105 in the MR space and the computer 107 to which the speaker 105 is connected. If any music performance event occurs in the MR space, the speaker 105 can be caused to produce sound, which is located in the vicinity of the location in the MR space where the music performance event has occurred.

The MR space status managing software 400 manages the locations, orientations, and status of all the real space objects and the locations, orientations, and status of all the virtual space objects. For the locations, orientations, and status of the real space objects, the MR space status managing software 400 is periodically notified of the observer's eye position and line-of-sight direction as well as the position, orientation, and gesture from the hand position and orientation sensory receiver 103 from the MR image generating software 310. The reception of these pieces of information is carried out whenever necessary, and timing in which the reception is to be carried out need not be considered. The locations, orientations, and status of the virtual space objects are periodically notified by a virtual space status managing section 401 in the MR space status managing software 400.

The MR space status managing software 400 periodically transmits these piece of information to the MR image generating software 310 operating in the computers 107 for all the observers.

The virtual space status managing section 401 manages and controls all matters related to the virtual space. Specifically, it executes processes such as a process of allowing the time in the virtual space to elapse and causing all the virtual space objects to operate according to a preset scenario. Further, the virtual space status managing section 401 serves to proceed with the scenario in response to any interaction between the observer, that is, a real space object and a virtual space object (for example, the virtual space object is exploded when the coordinates of the real and virtual space objects agree with each other) or any gesture input.

The MR image generating software 310 generates an MR space image for the observer and outputs the generated image to the display devices 201 and 202 of the observer's HMD 101. The process associated with this output is divided among a status transmitting and receiving section 313, a virtual image generating section 311, a real image obtaining section 312, and an image synthesizing section 314 inside the MR image generating software 310.

The status transmitting and receiving section 313 periodically notifies the MR space status managing software 400 of the observer's eye position and line-of-sight direction transmitted from the line-of-sight direction correcting software 350 as well as the position, orientation, and gesture from the hand position and orientation sensory receiver 103. Further, the status transmitting and receiving section 313 is periodically notified of the locations, orientations, and status of the objects present in all the MR spaces from the MR space status managing software 400. That is, for the real space objects, the status transmitting and receiving section 313 is notified of the other observers' eye positions and line-of-sight directions as well as the positions, orientations, and gestures from the hand position and orientation sensory receivers 103. For the virtual space objects, the status transmitting and receiving section 313 is notified of the locations, orientations, and status of the virtual space objects managed by the virtual space status managing section 401. The status information can be received at any time, and timing in which the status information is to be received need not be considered.

The virtual image generating section 311 generates a virtual space image with a transparent background as viewed using the locations, orientations, and status of the virtual space objects transmitted from the MR space status managing software 400 and the observer's eye position and line-of-sight direction transmitted from the line-of-sight direction correcting software 350.

The real image obtaining section 312 captures real space images from the right-eye and left-eye video capture boards 150 and 151, and stores them in a predetermined area of the memory 157 or HDD 155 (shown in FIG. 7) for updating.

The image synthesizing section 314 reads out the real space images generated by the above section, from the memory 157 or HDD 155, superposes them on the virtual space image, and outputs the superposed image to the display devices 201 and 202.

The above-described hardware and software can thus provide an MR space image to each observer.

The MR space images viewed by the observers have the status thereof collectively managed by the MR space status managing software 400 and can thus be synchronized in timing with each other.

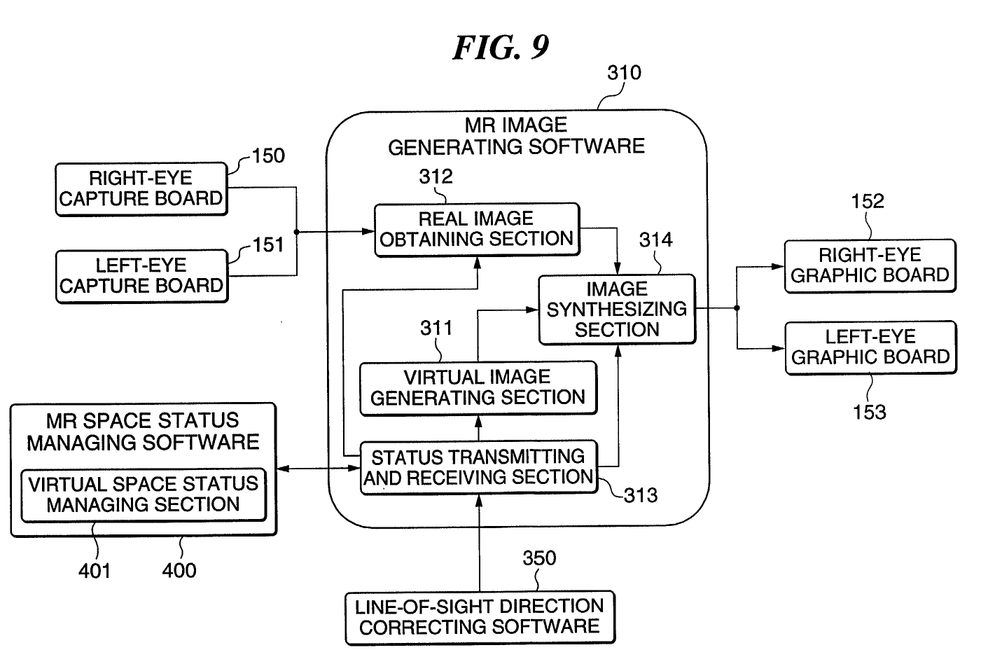

Now, the details of the operation of the MR image generating software, which reduces timing deviation between the real space image and the virtual space image, will be described with reference to FIGS. 9 to 11.

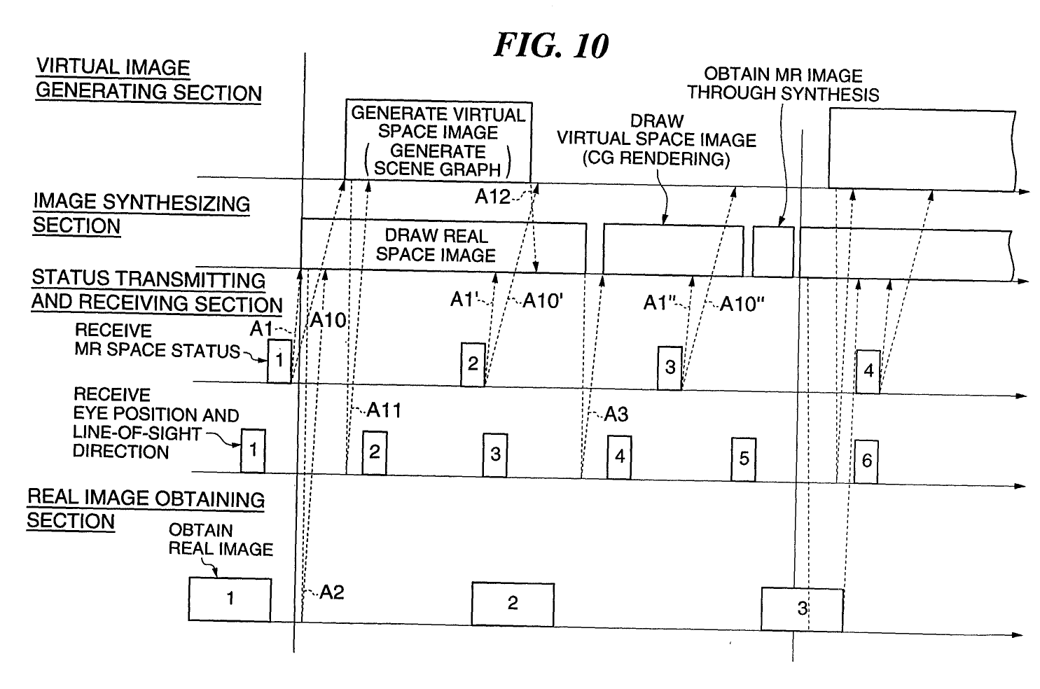

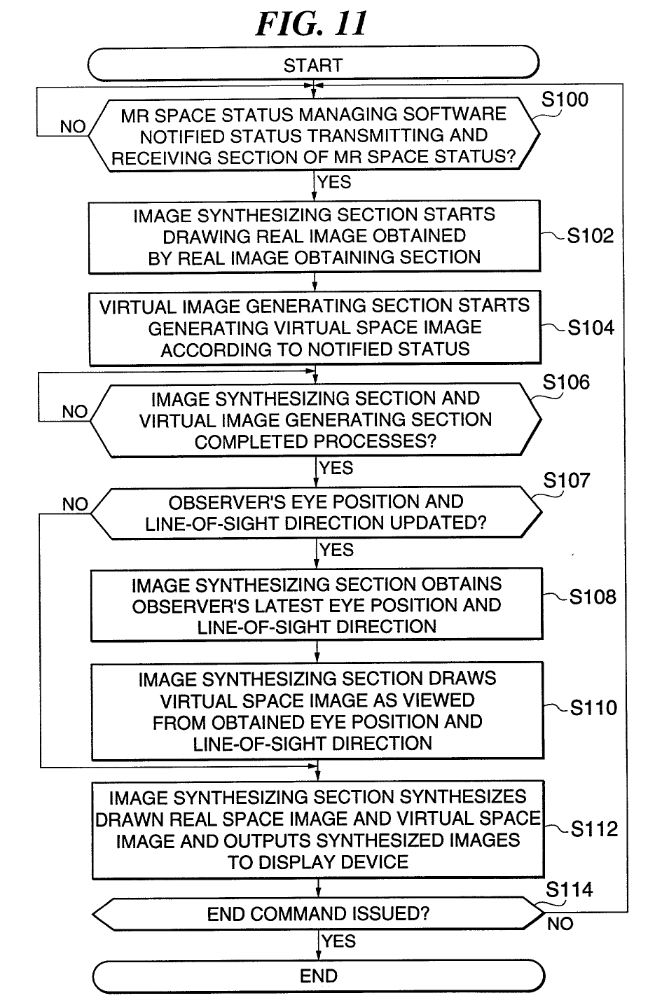

FIG. 9 is a view schematically showing hardware and software associated with generation of an MR space image by the image generating system in FIG. 1 as well as the flow of related information. FIG. 10 is a timing chart showing operation timing for the MR vide generating software in FIG. 9. FIG. 11 is a flow chart showing the operation of the MR image generating software in FIG. 9.

In the MR image generating software 310, as shown in FIGS. 9 and 11, when the status transmitting and receiving section 313 is notified of the MR space status from the MR space status managing software 400(step S100), a command for drawing a real space image is issued to the image synthesizing section 314 and a command for generating a virtual space image is issued to the virtual image generating section 311 (A1 and A10, shown in FIG. 10).

Upon receiving the command, the image synthesizing section 314 copies the latest real image data from the real image obtaining section 312 (A2 in FIG. 10), and starts drawing an image on the memory 157 of the computer 107 (step S102).

The virtual image generating section 311 starts creating the locations, orientations, and status of the virtual objects in the virtual space as well as the observer's eye position and line-of-sight direction in a status description form called “scene graph” (A11 in FIG. 10; step S104).

In the present embodiment, the steps S102 and S104 are sequentially processed, but these steps may be processed in parallel using a multithread technique.

Then, the MR image generating software 310 waits for the real space image drawing process of the image synthesizing section 314 and the virtual space image generating process of the virtual image generating section 312 to be completed (A12; step S106). Once the real space vide drawing process of the image synthesizing section 314 and the virtual space image generating process of the virtual image generating section 312 are completed, the MR image generating software 310 issues a command for drawing a virtual space image to the image synthesizing section 314.

The image synthesizing section 314 checks whether or not the information on the observer's eye position and line-of-sight direction has been updated (step S107). If this information has been updated, the image synthesizing section 314 obtains the latest eye position and line-of-sight direction (step S108) and draws a virtual image as viewed at the latest eye position and in the latest line-of-sight direction (step S110). The process of changing the eye position and line-of-sight direction and drawing a new image is executed in a negligibly short time compared to the entire drawing time, thus posing no problem. If the above information has not been updated, the image synthesizing section 314 skips the steps S108 and S110 to continue drawing the virtual space image.

Then, the image synthesizing section 314 synthesizes the drawn real space image and virtual space image and outputs the synthesized image to the display device 210 (step S112).

The series of MR space image generating processes are thus completed. Then, it is checked whether or not an end command has been received. If the command has been received, the whole process is completed. If the command has not been received, the above processes are repeated (step S114).

During the above series of processes, the status transmitting and receiving section 314 may receive a new status from the MR space status managing software 400. In such a case, this fact is notified as shown in A1′, A10′, A1″, and A10″, but this notification is neglected until the image synthesizing section 314 checks whether or not a notification of the MR space status has been received at the above step S100.

In the above described manner, the status of MR space images which are viewed by the observers is collectively managed by the MR space status managing software 400, so that the real space image and the virtual space image can be temporally synchronized with each other. Thus, if a plurality of observers simultaneously use the present system, they can view images of the same time. Further, the latest information on the observer's position and orientation can be used, thereby reducing timing deviation between the real space image and the virtual space image. In particular, when the HMD 101 is used as a display device for providing an MR space image to the observer, the system responds more quickly when the observer shakes his head.

As described above, the present system can reduce timing deviation between the real space image and the virtual space image to thereby provide the observer with an MR space image that makes him more absorbed in the virtual space.

It goes without saying that the object of the present invention may also be achieved by supplying a system or an apparatus with a storage medium which stores program code of software that realizes the functions of the above-described embodiment (including the flow chart shown in FIG. 11), and causing a computer (or CPU or MPU) of the system or apparatus to read out and execute the program code stored in the storage medium.

In this case, the program code itself read out from the storage medium realizes the functions of the embodiment described above, so that the storage medium storing the program code also constitutes the present invention.

The storage medium for supplying the program code may be selected, for example, from a floppy disk, hard disk, optical disk, magneto-optical disk, CD-ROM, CD-R, magnetic tape, non-volatile memory card, ROM, and DVD-ROM.

It is to be understood that the functions of the embodiment described above can be realized not only by executing a program code read out by a computer, but also by causing an operating system (OS) that operates on the computer to perform a part or the whole of the actual operations according to instructions of the program code.

Furthermore, the program code read out from the storage medium may be written into a memory provided in an expanded board inserted in the computer, or an expanded unit connected to the computer, and a CPU or the like provided in the expanded board or expanded unit may actually perform a part or all of the operations according to the instructions of the program code, so as to accomplish the functions of the embodiment described above.

As described above, the image generating system according to the present invention comprises image pickup means for capturing an image of a real space at an eye position of an observer and in a line-of-sight direction of the observer, detecting means for detecting the eye position and line-of-sight direction of the observer, virtual space image generating means for generating an image of a virtual space at the eye position of the observer and in the line-of-sight direction of the observer, the eye position and the line-of-sight direction being detected by the detecting means, composite image generating means for generating a composite image by synthesizing the image of the virtual space generated by the virtual space image generating means and the image of the real space outputted by the image pickup means, display means for displaying the composite image generated by the composite image generating means, and managing means for collectively managing information on objects present in the real space and the virtual space as well as locations and orientations thereof. As a result, timing deviation between the real space image and the virtual space image can be reduced to thereby provide the observer with a composite image that makes him more absorbed in the virtual space.

Further, the image generating method according to the present invention comprises the steps of detecting an eye position and a line-of-sight direction of an observer, obtaining an image of a real space at the eye position of the observer and in the line-of-sight direction of the observer, obtaining management information containing objects present in the real space and a virtual space as well as locations and orientations thereof, generating an image of a virtual space at the eye position of the observer and in the line-of-sight direction of the observer based on the management information, and generating a composite image by synthesizing the image of the virtual space and the image of the real space based on the management information. As a result, timing deviation between the real space image and the virtual space image can be reduced to thereby provide the observer with a composite image that makes him more absorbed in the virtual space.

Moreover, the storage medium according to the present invention stores a program which comprises a detecting module for causing detecting means to detect an eye position and line-of-sight direction of an observer, a virtual space image generating module for generating an image of a virtual space at the eye position of the observer and in the line-of-sight direction of the observer, the eye position and the line-of-sight direction being detected by the detecting module, a composite image generating module for generating a composite image from the image of the virtual space generated by the virtual space image generating module and an image of a real space, and a managing module for collectively managing objects present in the real space and the virtual space as well as locations and orientations thereof. As a result, timing deviation between the real space image and the virtual space image can be reduced to thereby provide the observer with a composite image that makes him more absorbed in the virtual space.

What is claimed is:

1. An image generating system comprising:
image pickup means for capturing an image of a real space at an eye position of an observer and in a line-of-sight direction of the observer;
detecting means for detecting the eye position of the observer and the line-of-sight direction of the observer;
virtual space image generating means for generating an image of a virtual space at the eye position of the observer and in the line-of-sight direction of the observer, the eye position and the line-of-sight direction being detected by said detecting means;
composite image generating means for generating a composite image by synthesizing the image of the virtual space generated by said virtual space image generating means and the image of the real space outputted by said image pickup means;
display means for displaying the composite image generated by said composite image generating means; and
managing means for collectively managing information on objects present in the real space and the virtual space as well as locations and orientations thereof.

2. An image generating system according to claim 1, wherein said managing means can update the information on the objects present in the real space and the virtual space as well as the locations, orientations, and status thereof.

3. An image generating system according to claim 2, wherein said managing means notifies said composite image generating means of the information on the objects present in the real space and the virtual space as well as the locations, orientations, and status thereof, at predetermined time intervals.

4. An image generating system according to claim 3, wherein said virtual space image generating means is responsive to the updating of the information by said managing means, for generating the image of the virtual space based on the information on the objects present in the real space and the virtual space as well as the locations and orientations thereof.

5. An image generating system according to claim 3, wherein said composite image generating means is responsive to the updating of the information by said managing means, for starting drawing the image of the real space.

6. An image generating system according to claim 5, wherein said composite image generating means synthesizes the image of the real space and the image of the virtual space after said composite image generating means has completed drawing image of the real space and said virtual space image generating means has then generated the image of the virtual space.

7. An image generating system according to claim 6, wherein said composite image generating means regenerates the image of the virtual space based on the eye position of the observer and the line-of-sight direction of the observer detected by said detecting means, immediately before synthesizing the image of the real space and the image of the virtual space.

8. An image generating system according to claim 3, wherein said virtual space image generating means executes a process of generating an image of the virtual space based on the information on the objects present in the real space and the virtual space as well as the locations and orientations thereof, according to the information updated by said managing means, and said composite image generating means executes a process of starting drawing the image of the real space in parallel with the process of generating the image of the virtual space, executed by said virtual space image generating means.

9. An image generating system according to claim 1, wherein the observer comprises a plurality of observers.

10. An image generating system according to claim 9, further comprising operation detecting means for detecting an operation of the observer including a gesture and status thereof based on results of the detection by said detecting means.

11. An image generating system according to claim 10, wherein the operation of the observer detected by said operation detecting means can be used as an input that acts on a space in which the composite image is present and objects present in the space.

12. An image generating method of generating a composite image by synthesizing an image of a virtual space on an image of a real space obtained at an eye position of an observer and in the line-of-sight direction of the observer, the method comprising the steps of:
detecting the eye position and the line-of-sight direction of the observer;
obtaining the image of the real space at the eye position of the observer and in the line-of-sight direction of the observer;
obtaining management information containing objects present in the real space and the virtual space as well as locations and orientations thereof;
generating the image of the virtual space at the eye position of the observer and in the line-of-sight direction of the observer based on the management information; and
generating a composite image by synthesizing the image of the virtual space and the image of the real space based on the management information.

13. An image generating method according to claim 12, further comprising the step of updating the management information.

14. An image generating method according to claim 13, wherein the management information is notified to said step of generating a composite image, at predetermined time intervals.

15. An image generating method according to claim 14, wherein said step of generating the image of the virtual space is executed based on the objects present in the real space and the virtual space as well as the locations and orientations thereof, in response to the updating of the information.

16. An image generating method according to claim 15, wherein when the composite image is generated, drawing of the obtained image of the real space is started in response to the updating of the information.

17. An image generating method according to claim 16, wherein said step of generating the composite image is executed by synthesizing the image of the real space and the image of the virtual space after the drawing of the image of the real space has been completed and the image of the virtual space has been generated in said step of generating the image of the virtual space.

18. An image generating method according to claim 17, wherein regeneration of the image of the virtual 17, wherein regeneration of the image of the virtual space is executed based on the detected eye position and line-of-sight direction of the observer, immediately before the image of the real space and the image of the virtual space are synthesized.

19. An image generating method according to claim 14, wherein generation of the image of the virutal space is started in response to the updating of the management information, and drawing of the obtained image of the real space in connection with the generation of the composite image is started in response to the updating of the management information, and wherein the generation of the image of the virutal space and the drawing of the image of the real space are executed in parallel with each other.

20. An image generating method according to claim 19, wherein the observer comprises a plurality of observers.

21. An image generating method according to claim 20, further comprising the step of detecting an operation of the observer including a gesture and status thereof based on the eye position and line-of-sight direction of the observer.

22. An image generating method according to claim 21, wherein the detected operation of the observer can be used as an input that acts on a space in which the composite image is present and objects present present

23. A computer-readable storage medium storing a program for generating a composite image, which is executed by an image generating system comprising image pickup means for capturing an image of a real space at an eye position of an observer and in a line-of-sight direction of the observer, detecting means for detecting the eye position of the observer and the line-of-sight direction of the observer, and display means for displaying a composite image obtained by synthesizing the image of the real space and an image of a virtual space generated at the eye position of the observer and in the line-of-sight direction of the observer, the program comprising:
a detecting module for causing the detecting means to detect an eye position and line-of-sight direction of an observer;
a virtual space image generating module for generating an image of a virtual space at the eye position of the observer and in the line-of-sight direction of the observer, the eye position and the line-of-sight direction being detected by said detecting module;
a composite image generating module for generating a composite image from the image of the virtual space generated by said virtual space image generating module and an image of a real space; and
a managing module for collectively managing objects present in the real space and the virtual space as well as locations and orientations thereof.

24. A storage medium according to claim 23, wherein said managing module can update the information on the objects present in the real space and the virtual space as well as the locations, orientations, and status thereof.

25. A storage medium according to claim 24, wherein said managing module notifies said composite image generating module of the information on the objects present in the real space and the virtual space as well as the locations, orientations, and status thereof, at predetermined time intervals.

26. A storage medium according to claim 25, wherein said virtual space image generating module is responsive to the updating of the information by said managing module, for generating the image of the virtual space based on the information on the objects present in the real space and the virtual space as well as the locations and orientations thereof.

27. A storage medium according to claim 26, wherein said composite image generating module is responsive to the updating of the information by said managing module, for starting drawing the image of the real space.

28. A storage medium according to claim 27, wherein said composite image generating module synthesizes the image of the real space and the image of the virtual space after said composite image generating module has completed drawing image of the real space and said virtual space image generating module has then generated the image of the virtual space.

29. A storage medium according to claim 27, wherein said composite image generating module regenerates the image of the virtual space based on the eye position of the observer and the line-of-sight direction of the observer detected by said detecting module, immediately before synthesizing the image of the real space and the image of the virtual space.

30. A storage medium according to claim 25, wherein said virtual space image generating module executes a process of generating an image of the virtual space based on the information on the objects present in the real space and the virtual space as well as the locations and orientations thereof, according to the information updated by said managing module, and said composite image generating module executes a process of starting drawing the image of the real space in parallel with the process of generating the image of the virtual space, executed by said virtual space image generating module.

31. A storage medium according to claim 23, wherein the observer comprises a plurality of observers.

32. A storage medium according to claim 23, further comprising an operation detecting module for detecting an operation of the observer including a gesture and status thereof based on results of the detection by said detecting module.

33. A storage medium according to claim 23, wherein the operation of the observer detected by said operation detecting module can be used as an input that acts on a space in which the composite image is present and objects present in the space.
